(19) United States
(12) Patent Application Publication
(10) Pub. No.: US 2010/0204323 A1
(43) Pub. Date: Aug. 12, 2010

(54) ANTIMICROBIAL COMPOSITIONS COMPRISING ORGANIC ACID ESTERS AND METHODS FOR REDUCING VIRUS AND BACTERIAL POPULATIONS USING SUCH COMPOSITIONS

(75) Inventors: Richard F. Theiler, Scottsdale, AZ (US); Earl P. Seitz, JR., Scottsdale, AZ (US); Janice L. Fuls, Fountain Hills, AZ (US)

Correspondence Address: THE DIAL CORPORATION, 19001 N. Scottsdale Road, SCOTTSDALE, AZ, 85255, US

(73) Assignee: The Dial Corporation, Scottdale, AZ (US)

(21) Appl. No.: 12/764,632

(22) Filed: Apr. 21, 2010

Related U.S. Application Data
(63) Continuation-in-part of application No. 11/791,257, filed on Mar. 4, 2008.
(60) Provisional application No. 60/634,464, filed on Dec. 9, 2004.

(51) Int. Cl. A01N 37/02; A01N 31/00; A01P 1/00

(52) U.S. Cl. 514/547; 514/724; 514/546

(57) ABSTRACT

Antimicrobial compositions comprising organic acid esters and methods for reducing virus and/or bacteria populations using such compositions are provided. In one embodiment, an antimicrobial composition comprises a virucidally effective amount of an organic acid ester, the organic acid ester having a pKₐ₁ value in the range of from about 3 to about 4.5. The composition further comprises a disinfecting alcohol present in an amount of 0 wt. % to about 75 wt. % and a carrier. The antimicrobial composition has a pH of no greater than about 5 at 25° C.

### CROSS-REFERENCES TO RELATED APPLICATIONS

This is a continuation-in-part of application Ser. No. 11/791,257, filed Mar. 4, 2008, which is the U.S. national phase of PCT Application No. PCT/US2005/043910, filed Dec. 5, 2005, which claims the benefit of U.S. Provisional Application No. 60/634,464, filed Dec. 9, 2004.

### FIELD OF THE INVENTION

The present invention generally relates to antiviral compositions and methods for reducing a viral population using the antiviral compositions, and more particularly relates to antimicrobial compositions comprising organic acid esters and methods for reducing viral and bacterial populations using the antimicrobial compositions.

### BACKGROUND OF THE INVENTION

Human health is impacted by a variety of microbes encountered on a daily basis. In particular, contact with various microbes in the environment can lead to an illness, possibly severe, in mammals. For example, microbial contamination can lead to a variety of illnesses, including, but not limited to, food poisoning, a streptococcal infection, anthrax (cutaneous), athlete's foot, cold sores, conjunctivitis (“pink eye”), coxsackievirus (hand-foot-mouth disease), croup, diphtheria (cutaneous), ebolic hemorrhagic fever, and impetigo.

Viruses are a category of pathogens of primary concern. Viral infections are among the greatest causes of human morbidity, with an estimated 60% or more of all episodes of human illness in developed countries resulting from a viral infection. In addition, viruses infect virtually every organism in nature, with high virus infection rates occurring among all mammals, including humans, pets, livestock, and zoo specimens.

Viruses exhibit an extensive diversity in structure and life cycle. A detailed description of virus families, their structures, life cycles, and modes of viral infection is discussed in Fundamental Virology, 4th Ed., Eds. Knipe & Howley, Lippincott Williams & Wilkins, Philadelphia, Pa., 2001.

Simply stated, virus particles are intrinsic obligate parasites, and have evolved to transfer genetic material between cells and encode sufficient information to ensure their propagation. In a most basic form, a virus consists of a small segment of nucleic acid encased in a simple protein shell. The broadest distinction between viruses is the enveloped and nonenveloped viruses, i.e., those that do or do not contain, respectively, a lipid-bilayer membrane.

Viruses propagate only within living cells. The principal obstacle encountered by a virus is gaining entry into the cell, which is protected by a cell membrane of thickness comparable to the size of the virus. In order to penetrate a cell, a virus first must become attached to the cell surface. Much of the specificity of a virus for a certain type of cell lies in its ability to attach to the surface of that specific cell. Durable contact is important for the virus to infect the host cell, and the ability of the virus and the cell surface to interact is a property of both the virus and the host cell. The fusion of viral and host-cell membranes allows the intact viral particle, or, in certain cases, only its infectious nucleic acid to enter the cell. Therefore, in order to control a viral infection, it is important to rapidly kill a virus that contacts the skin, and ideally to provide a persistent and long-term antiviral activity on the skin, or a hard surface.

Common household phenol/alcohol disinfectants are effective in disinfecting contaminated environmental surfaces, but lack persistent virucidal activity. Hand washing is highly effective in disinfecting contaminated fingers, but again suffers from a lack of persistent activity. These shortcomings illustrate the need for improved virucidal compositions having a persistent activity against viruses.

Antibacterial cleansing compositions, which typically are used to cleanse the skin and to destroy bacteria present on the skin, especially the hands, arms, and face of the user, are well-known commercial products. Antibacterial compositions are used, for example, in the health care industry, food service industry, meat processing industry, and in the private sector by individual consumers. The widespread use of antibacterial compositions indicates the importance consumers place on controlling bacteria populations on skin. The paradigm for antibacterial compositions is to provide a substantial and broad spectrum reduction in bacterial populations quickly and without adverse side effects associated with toxicity and skin irritation.

One class of antibacterial personal care compositions is the hand sanitizer gels. This class of compositions is used primarily by medical personnel to disinfect the hands and fingers. A hand sanitizer gel is applied to, and rubbed into, the hands and fingers, and the composition is allowed to evaporate from the skin.

Hand sanitizer gels contain a high percentage of an alcohol, like ethanol. At the high percent of alcohol present in the gel, the alcohol itself acts as a disinfectant. In general, hand sanitizer gels typically contain: (a) at least 60% by volume ethanol or a combination of lower alcohols, such as ethanol and isopropanol, (b) water, (c) a gelling polymer, such as a crosslinked polyacrylate material, and (d) other ingredients, such as skin conditioners, fragrances, and the like. Hand sanitizer gels are used by consumers to effectively sanitize the hands, without, or after, washing with soap and water, by rubbing the hand sanitizer gel on the surface of the hands. Current commercial hand sanitizer gels rely on high levels of alcohol for disinfection and evaporation, and thus suffer from disadvantages. Specifically, because of the volatility of ethanol, the primary antimicrobial agent does not remain on the skin after use, thus failing to provide a persistent antimicrobial effect.

At alcohol concentrations below 60% by volume, ethanol is not recognized as an antiseptic. Thus, in compositions containing less than 60% alcohol, an additional antimicrobial compound is present to provide antimicrobial activity. Several different classes of antibacterial agents have been used in antibacterial cleansing compositions. Examples of antibacterial agents include a bisguanidine (e.g., chlorhexidine digluconate), diphenyl compounds, benzyl alcohols, trihalocarbanilides, quaternary ammonium compounds, ethoxylated phenols, and phenolic compounds, such as halo-substituted phenolic compounds, like PCMX (i.e., p-chloro-m-xylenol) and triclosan (i.e., 2,4,4′-trichloro-2′-hydroxydiphenylether). Antimicrobial compositions based on such antibacterial agents exhibit a wide range of antibacterial activity, ranging from low to high, depending on the microorganism to be controlled and the particular antibacterial composition. Most commercial antibacterial compositions generally offer a low to moderate antibacterial activity, and no reported antiviral activity.

Virus control poses a more difficult problem than bacterial control. By sufficiently reducing bacterial populations, the risk of bacterial infection is reduced to acceptable levels. Therefore, a rapid antibacterial kill is desired. With respect to viruses, however, not only is a rapid kill desired, but a persistent, i.e., long-term, antiviral activity also is required. This difference is because merely reducing a virus population is insufficient to reduce infection. In theory, a single virus can cause infection. Therefore, an essentially total, and persistent, antiviral activity is required, or at least desired, for an effective antiviral cleansing composition.

An efficacious antimicrobial composition effective against both bacteria and viruses has been difficult to achieve because of the fundamental differences between bacteria and viruses. Although a number of antimicrobial cleansing products currently exist, taking a variety of product forms (e.g., antibacterial soaps, hard surface cleaners, and surgical disinfectants), such antimicrobial products typically incorporate antimicrobial agents, e.g., a phenolic compound, and/or harsh surfactants that can dry out and irritate skin tissues. Ideally, personal cleansing products gently cleanse the skin, cause little or no irritation, and do not leave the skin overly dry after frequent use.

Accordingly, it is desirable to provide an antimicrobial composition that is highly efficacious against a broad spectrum of microbes, including viruses and bacteria, in a short time period, can provide a persistent and broad spectrum antiviral activity, and is mild to the skin. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In accordance with an exemplary embodiment, an antimicrobial composition is provided. The antimicrobial composition comprises a virucidally effective amount of a first organic acid ester, the first organic acid ester having a pKₐ₁ value in the range of from about 3 to about 4.5. The composition further comprises a disinfecting alcohol present in an amount of 0 wt. % to about 75 wt. % and a carrier. The antimicrobial composition has a pH of no greater than about 5 at 25° C.

In accordance with another exemplary embodiment, a method of reducing a bacterial population, a virus population, or a combination thereof on a surface is provided. The method comprises contacting the surface with a composition. The composition comprises a virucidally effective amount of a first organic acid ester, the first organic acid ester having a pKₐ₁ value in the range of from about 3 to about 4.5. The composition further comprises a disinfecting alcohol in an amount of 0 wt. % to about 75 wt. % and a carrier. The composition has a pH of no greater than about 5 at 25° C.

In accordance with a further exemplary embodiment, a method of reducing a bacterial population, a virus population, or a combination thereof on a surface is provided. The method comprises selecting an organic acid having a first value of a property and selecting an ester of the organic acid. The ester has a pKₐ₁ value in the range of from about 3 to about 4.5 and has a second value of the property, wherein the first value is not equal to the second value. The organic acid and the ester of the organic acid are combined with a carrier to form an antimicrobial composition having a pH of no greater than about 5 at 25° C. The surface is contacted with the antimicrobial composition.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The various embodiments of the antimicrobial compositions contemplated herein provide excellent broad spectrum antiviral and antibacterial efficacy and significantly improve antiviral efficacy compared to prior compositions that incorporate a high percentage of an alcohol, i.e., 40% or greater, by weight. The basis of this improved efficacy is the discovery that organic acid esters having a dissociation constant pKₐ₁ in the range of about 3 to about 4.5 substantially improve antiviral efficacy on an animate or inanimate surface after application of the ester to the surface and after a sustained period. With a dissociation constant in this given range, the organic acid ester is capable of lowering the pH of a surface so as to kill a virus and a bacterium immediately upon contact and also has a buffering capacity that suppresses pH, thus providing persistent acidification of viruses. In one embodiment, the antimicrobial composition comprises an organic acid ester having a dissociation constant pKₐ₁ in the range of 3.5 to 4. In another preferred embodiment, the antimicrobial composition comprises a disinfecting alcohol in addition to the organic acid ester.

In particular, in accordance with exemplary embodiments, an antimicrobial composition of the present invention comprises: (a) a virucidally effective amount of an organic acid ester having a pKₐ₁ in the range of about 3 to about 4.5; (b) about 0 weight percent (wt. %) to about 75 wt. % of a disinfecting alcohol, and (c) a carrier. The composition has a pH of less than about 5. To reduce a virus and bacterium population from a surface, such as skin, the composition is applied to the surface, such as by wiping, rubbing, etc. the composition onto the surface. The composition is mild, and it is not necessary to rinse or wipe the composition from the skin.

The antimicrobial compositions of the present invention are highly efficacious in household cleaning applications (e.g., hard surfaces, like floors, countertops, tubs, dishes, and soft cloth materials, like clothing), personal care applications (e.g., lotions, shower gels, soaps, shampoos, and wipes), and industrial and hospital applications (e.g., sterilization of instruments, medical devices, and gloves). The present compositions efficaciously and rapidly disinfect surfaces that are infected or contaminated with bacteria, non-enveloped viruses (e.g., rhinoviruses and rotaviruses), and enveloped viruses (e.g. influenza A, B, and C, thogotovirus and isavirus). The present compositions also provide a persistent antiviral effectiveness.

The present compositions can be used in vitro and in vivo. In vitro means in or on nonliving things, especially on inanimate objects having hard or soft surfaces located or used where preventing viral transmission is desired, most especially on objects that are touched by human hands. In vivo means in or on animate objects, especially on mammal skin, and particularly on hands.

Organic Acid Esters

In accordance with an exemplary embodiment of the present invention, an organic acid ester included in an antimicrobial composition contemplated herein preferably does not penetrate the surface to which it is applied, e.g., remains on the skin surface as opposed to penetrating the skin. The organic acid ester, therefore, preferably is a hydrophobic organic acid ester. Accordingly, the organic acid ester of the antimicrobial composition further has a log P of one or greater. As used herein, the term “log P” is defined as the log of the octanol-water partition coefficient, i.e., the log of the ratio Pₒ/P_{w}, wherein Pₒ is the concentration of an organic acid ester in octanol and P_{w} is the concentration of the organic acid ester in water, at equilibrium and 25° C. The octanol-water coefficient can be determined by the U.S. Environmental Protection Agency Procedure, “OPPTS 830.7560 Partition Coefficient (n-Octanol/Water), Generator Column Method” (1996). Organic acid esters having a higher log P typically are more water insoluble and are thought to provide more of an antibacterial efficacy than organic acid esters having a lower log P, which typically are considered more water soluble and also envisioned to act more to improve antiviral efficacy.

In one exemplary embodiment, the organic acid ester has a log P of 1 or greater, for example, 1 to about 100. In this embodiment, the organic acid ester acts to provide an effective and persistent viral control and bacteria control. In another embodiment of the present invention, the organic acid ester has a log P of less than one, and preferably less than 0.75. More preferably, the organic acid ester has a log P of less than 0.5. Accordingly, in another exemplary embodiment, a combination of a first organic acid ester having a log P of no less than one and a second organic acid ester having a log P of less than 1 act synergistically to provide a persistent control of viruses and a broad spectrum bacteria control.

In another exemplary embodiment, the compositions contemplated herein also comprise disinfecting alcohol. For example, in one embodiment, the organic acid ester has a log P of less than one, preferably less than 0.75, more preferably 0.5 and, with the disinfecting alcohol, effectively controls viruses and also acts synergistically with the alcohol to control a broad spectrum of bacterial. In a preferred embodiment, the composition comprises a first organic acid ester having a log P of no less than one, a second organic acid ester having a log P of less than 1, and disinfecting alcohol that all synergistically act to provide superior persistent viral control and a broad spectrum of bacteria control.

Antimicrobial compositions contemplated herein contain a “virucidally effective amount” of an organic acid ester. As used herein, a “virucidally effective amount” is a sufficient amount to inactivate and destroy viruses and bacteria on a surface contacted by the antimicrobial composition and provide persistent antiviral efficacy.

As used herein, the term “persistent antiviral efficacy” or “persistent antiviral activity” means leaving a residue or imparting a condition on animate (e.g., skin) or inanimate surfaces that provides significant antiviral activity for an extended time after application. Antimicrobial activity is assessed as the log reduction, or alternatively the percent reduction, in microbial populations provided by the antimicrobial composition. A 1-3 log reduction is preferred, a log reduction of 3-5 is most preferred, for a particular contact time, generally ranging from 15 seconds to 5 minutes. Thus, a highly preferred antimicrobial composition exhibits a 3-5 log reduction against a broad spectrum of microorganisms in a short contact time.

A composition of the present invention provides a persistent antiviral efficacy, i.e., preferably a log reduction of at least 3, and more preferably a log reduction of at least log 4, against enveloped and nonenveloped viruses, such as rhinovirus and rotavirus serotypes, within 30 seconds of contact with the composition. Antiviral activity is maintained for at least about 0.5 hour, preferably at least about one hour, and more preferably for at least about two hours, at least about three hours, or at least about four hours after contact with the composition. In some preferred embodiments, antiviral activity is maintained for about six to about eight hours after contact with the composition.

In particular, an organic acid ester is present in the composition in a sufficient amount such that the pH of the animate or inanimate surface contacted by the composition is lowered to degree wherein a persistent viral control is achieved. This persistent viral control is achieved regardless of whether the composition is rinsed from, or allowed to remain on, the contacted surface. The organic acid ester remains at least partially undissociated in the composition, and remains so when the composition is diluted, or during application and rinsing.

Upon application to a surface, such as human skin, the pH of the surface is sufficiently lowered such that a persistent viral control is achieved. In preferred embodiments, a residual amount of the organic acid ester remains on the skin, even after a rinsing step, in order to impart a persistent viral control. However, even if the organic acid ester is essentially completely rinsed from the surface, the surface pH has been sufficiently lowered to impart a viral control for at least 0.5 hour.

In an exemplary embodiment, an organic acid ester is included in an antimicrobial composition contemplated herein in an amount of about 0.05% to about 6%, and preferably about 0.1% to about 5%, by weight of the composition. In a more preferred embodiment, the organic acid ester is present in an amount of about 0.15% to about 4%, by weight of the composition. The amount of organic acid ester is related to the class of organic acid ester used, and to the identity of the specific ester or esters used.

The organic acid ester can comprise an ester of a polycarboxylic acid. There are several naming systems in use for polycarboxylic acids and their esters. For example in The Merck Index (Eleventh Ed., S. Budavari, ed., Merck & Co., Inc., Rahway, N.J. (1989)), the entry for compound #4367 cites the following names: glutaric acid, pentanedioic acid, and 1,3-propanedicarboxylic acid. Similarly, the entry for #152 includes the following: adipic acid, hexanedioic acid, and 1,4-butanedicarboxylic acid. The entry for #2328 includes citric acid, 2-hydroxy-1,2,3-propanetricarboxylic acid, and β-hydroxytricarballylic acid.

There is also precedent in this reference for naming esters as a combination of the root carboxylic acid name plus a name indicating the type of ester. For example, names for compound #3243 include: dimethyl phthalate, 1,2-benzenedicarboxylic acid dimethyl ester, and phthalic acid dimethyl ester. The entry for #3733 includes ethyl butyrate, butanoic acid ethyl ester, butyric acid ethyl ester, and ethyl n-butyrate. The entry for #3812 includes ethyl tartrate acid, (R)-2,3-dihydroxybutanedioic acid monoethyl ester, and monoethyl tartarate.

For the purposes of this application, the general approach of naming the parent acid first followed by a description of the carboxylic acid groups that are esterified and the type of ester that is formed for each will be used. For the parent acid, typically either the common name or the names that include dicarboxylic acid, tricarboxylic acid, tetracarboxylic acid, etc. will be used. Terms like “monoethyl ester” etc. are used when unambiguous. Ester names with positional information are used when needed. The following are examples of naming conventions used herein:

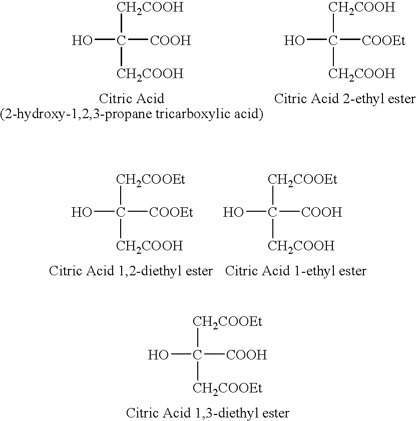

The polycarboxylic acids from which the ester derives can be unsubstituted, substituted, saturated, unsaturated, or combinations thereof. The organic acid ester also can contain other moieties, for example, hydroxy groups. Examples of esters suitable for use in the antimicrobial compositions contemplated herein include esters of malonic acid, including monoethyl malonate; esters of succinic acid, including monoethyl succinate; esters of glutaric acid including the monoethyl ester of glutaric acid; the esters of adipic acid including the monoethyl ester; the esters of pimelic acid including the monoethyl ester; the esters of suberic acid including the monoethyl ester; the esters of azelaic acid including the monoethyl ester; the esters of sebacic acid including the monoethyl ester; the esters of methylmalonic acid including the monoethyl ester; the esters of dimethylmalonic acid including the monoethyl ester; the esters of maleic acid including the monoethyl ester; the esters of fumaric acid including the monoethyl ester; the esters of mesaconic acid including the 1-ethyl ester and the 2-ethyl ester; the esters of itaconic acid including the 2-ethyl ester and the 3-ethyl ester; the esters of citraconic acid including the 1-ethyl ester and the 2-ethyl ester; the esters of 1,2,3-propanetricarboxylic acid including the I-ethyl ester, the 2-ethyl ester, the 1,2-diethyl ester, and the 1,3-diethyl ester; the esters of 2-methylpropane-1,2,3-tricarboxylic acid including the 1-ethyl ester, the 2-ethyl ester, the 1,2-diethyl ester, and the 1,3-diethyl ester; the esters of 1,2,3,4-butanetetracarboxylic acid including the 1-ethyl ester, the 2-ethyl ester, the 1,2-diethyl ester, the 1,3-diethyl ester, the 1,4-diethyl ester, the 1,2,3-triethyl ester, and the 1,2,4-triethyl ester; the esters of cis-aconitic acid including the 1-ethyl ester, the 2-ethyl ester, the 3-ethyl ester, the 1,2-diethyl ester, the 1,3-diethyl ester, and the 2,3-diethyl ester; the esters of trans-aconitic acid including the 1-ethyl ester, the 2-ethyl ester, the 3-ethyl ester, the 1,2-diethyl ester, the 1,3-diethyl ester, and the 2,3-diethyl ester; the esters of DL-malic acid including the 1-ethyl ester and the 2-ethyl ester; the esters of tartronic acid including the monoethyl ester; the esters of citric acid including the 1-ethyl ester, the 2-ethyl ester, the 1,3-diethyl ester, and the 1,2-diethyl ester; the esters of citramalic acid including the 1-ethyl ester and the 2-ethyl ester; the esters of DL-tartaric acid including the 1-ethyl ester; the esters of galactaric acid including the 1-ethyl ester; the esters of D-glucaric acid including the monoethyl-ester; the esters of mesoxalic acid including the monoethyl ester; the esters of alpha-ketoglutaric acid including the 1-ethyl ester and the 3-ethyl ester; the esters of beta-ketoglutaric acid including the 1-ethyl ester; the esters of terephthalic acid including the monoethyl ester; the esters of isophthalic acid including the monoethyl ester; the esters of phthalic acid including the monoethyl ester; and the like. In a preferred embodiment, the organic acid ester is the 1-ethyl ester, the 2-ethyl ester, the 1,2-diethyl ester, and the 1,3-diethyl ester of citric acid and the 1-ethyl ester of malic acid.

Disinfecting Alcohol

Antimicrobial compositions of the present invention contain from about 0% to about 75%, by weight, of one or more disinfecting alcohols. In one embodiment, the disinfecting alcohol is present in an amount less than about 25 wt. %, such as when the organic acid ester has a pKₐ₁ constant such that it exhibits desired antiviral efficacy in the absence of a disinfecting alcohol. In another embodiment, the disinfecting alcohol is present in an amount from about 25 wt. % to about 75 wt. %. Preferred embodiments of the present invention contain about 30 wt. % to about 75 wt. % of a disinfecting alcohol. Most preferred embodiments contain about 30 wt. % to about 70% of a disinfecting alcohol. As used herein, the term “disinfecting alcohol” is a water-soluble alcohol containing one to six carbon atoms. Disinfecting alcohols include, but are not limited to, methanol, ethanol, propanol, and isopropyl alcohol.

Organic Acids

In another exemplary embodiment, the antimicrobial compositions contemplated herein comprise organic acids. Antimicrobial compositions having rapid antiviral and antibacterial effectiveness and a persistent antiviral effectiveness and comprising an organic acid are disclosed in U.S. application Ser. No. 11/791,257, filed May 22, 2007, owned by the assignee of the present application. The organic acid may be present in the compositions contemplated herein by deliberate addition of the organic acid during production of the compositions and/or may be present as a result of de-esterification of the organic acid esters of the compositions during production and/or storage of the compositions.

In this regard, in accordance with an exemplary embodiment, the organic acid ester of a composition contemplated herein is an ester of a parent organic acid of the composition, the ester being used to adjust a property of the parent organic acid. For example, citric acid may be selected for use in a contemplated antimicrobial composition because of its antiviral effectiveness and its known safety profile. However, citric acid has a pKₐ₁ of 3.06. If it is desired to have a more optimal buffer capacity of the antimicrobial composition, for example with a pKₐ₁ in the preferred range of 3.5 to 4, citric acid 2-ethyl ester, a citric acid ester having a pKₐ₁ of 3.71, can be added to the composition to provide a more optimum overall buffering capacity for the preferred pH range. Thus, with the addition of citric acid 2-ethyl ester, the general properties of the citric acid in the composition, including its safety profile, can be maintained in the composition, but the pKₐ₁ value of the composition can be optimized. Any of the above-identified organic acid esters and their corresponding organic acids can be used in the antimicrobial compositions contemplated herein.

Accordingly, the use of a parent organic acid/organic acid ester pairing in the antimicrobial compositions contemplated herein can be used to optimize molecular parameters of the compositions. In other words, by using one of an organic acid or a corresponding organic acid ester in the composition because of a desired first property of the acid or ester and using the other of the organic acid or the corresponding organic acid ester to optimize a second property, an antimicrobial composition with optimized antiviral and other properties can be achieved. Such properties include, but are not limited to, water solubility, partition coefficient, melting point, Hansen dispersion parameter, Hansen hydrogen bonding parameter, sum of partial positive charges, density, etc. Such properties may have an influence on skin substantivity, resistance to rinse-off from the skin, mildness, composition aesthetics, composition stability, physiochemical attributes, plasticizing, and the like. Thus, a method for producing an antimicrobial composition contemplated herein may include selecting an organic acid having a first value of a property, selecting an ester of the organic acid, the ester having a different, more desired, value of the property, and combining the organic acid, the ester, the carrier, described in more detail below, and, optionally, a disinfecting alcohol.

Carrier

In an exemplary embodiment, an antimicrobial composition contemplated herein comprises a carrier. Examples of suitable carriers include, but are not limited to, propylene glycol, dipropylene glycol, and water. In a preferred embodiment, the carrier comprises water.

Optional Ingredients

An antimicrobial composition contemplated herein also can contain functional additives well known to persons skilled in the art. The functional additives are present in a sufficient amount to perform their intended function and not adversely affect the antimicrobial efficacy of the composition. Functional additives typically are present, individually or collectively, from 0% to about 50%, by weight of the composition.

Classes of functional additives include, but are not limited to, hydrotropes, polyhydric solvents, gelling agents, antimicrobial agents, dyes, fragrances, pH adjusters, thickeners, viscosity modifiers, chelating agents, skin conditioners, emollients, preservatives, buffering agents, antioxidants, chelating agents, opacifiers, and similar classes of optional ingredients known to persons skilled in the art.

A hydrotrope is a compound that has an ability to enhance the water solubility of other compounds. A hydrotrope utilized in the present invention lacks surfactant properties, and typically is a short-chain alkyl aryl sulfonate. Specific examples of hydrotropes include, but are not limited to, sodium cumene sulfonate, ammonium cumene sulfonate, ammonium xylene sulfonate, potassium toluene sulfonate, sodium toluene sulfonate, sodium xylene sulfonate, toluene sulfonic acid, and xylene sulfonic acid. Other useful hydrotropes include sodium polynaphthalene sulfonate, sodium polystyrene sulfonate, sodium methyl naphthalene sulfonate, sodium camphor sulfonate, and disodium succinate. A hydrotrope, if present at all, is present in an amount of about 0.1% to about 30%, and preferably about 1% to about 20%, by weight of the composition. To achieve the full advantage of the present invention, a composition can contain about 2% to about 15%, by weight, of a hydrotrope.

The term “polyhydric solvent” as used herein is a water-soluble organic compound containing two to six, and typically two or three, hydroxyl groups. The term “water-soluble” means that the polyhydric solvent has a water solubility of at least 0.1 g of polyhydric solvent per 100 g of water at 25° C. There is no upper limit to the water solubility of the polyhydric solvent, e.g., the polyhydric solvent and water can be soluble in all proportions. The term polyhydric solvent, therefore, encompasses water-soluble diols, triols, and polyols. Specific examples of hydric solvents include, but are not limited to, ethylene glycol, propylene glycol, glycerol, diethylene glycol, dipropylene glycol, tripropylene glycol, hexylene glycol, butylene glycol, 1,2,6-hexanetriol, sorbitol, PEG-4, and similar polyhydroxy compounds. A polyhydric solvent, if present at all, is present in an amount of about 0.1% to about 30%, and preferably about 5% to about 30%, by weight of the composition. More preferably, the polyhydric solvent is present in an amount of about 10% to about 30% by weight of the composition. In contrast to a disinfecting alcohol, a polyhydric solvent contributes minimally, if at all, to the antimicrobial efficacy of the present composition.

Other specific classes of optional ingredients include inorganic phosphates, sulfates, and carbonates as buffering agents; EDTA and phosphates as chelating agents; and acids and bases as pH adjusters. Examples of preferred classes of optional basic pH adjusters are ammonia; mono-, di-, and tri-alkyl amines; mono-, di-, and tri-alkanolamines; alkali metal and alkaline earth metal hydroxides; and mixtures thereof. However, the identity of the basic pH adjuster is not limited, and any basic pH adjuster known in the art can be used. Specific, nonlimiting examples of basic pH adjusters are ammonia; sodium, potassium, and lithium hydroxide; monoethanolamine; triethylamine; isopropanolamine; diethanolamine; and triethanolamine. Examples of preferred classes of optional acidic pH adjusters are the mineral acids. Nonlimiting examples of mineral acids are hydrochloric acid, nitric acid, phosphoric acid, and sulfuric acid. The identity of the acidic pH adjuster is not limited and any acidic pH adjuster known in the art, alone or in combination, can be used. An optional alkanolamide to provide composition thickening can be, but is not limited to, cocamide MEA, cocamide DEA, soyamide DEA, lauramide DEA, oleamide MIPA, stearamide MEA, myristamide MEA, lauramide MEA, capramide DEA, ricinoleamide DEA, myristamide DEA, stearamide DEA, oleylamide DEA, tallowamide DEA, lauramide MIPA, tallowamide MEA, isostearamide DEA, isostearamide MEA, and mixtures thereof. Alkanolamides are noncleansing surfactants and are added, if at all, in small amounts to thicken the composition.

The present antimicrobial compositions also can contain about 0.01% to about 5%, by weight, and preferably 0.10% to about 3%, by weight, of an optional gelling agent. More preferably, the antimicrobial compositions contain about 0.25% to about 2.5%, by weight, of a gelling agent. The antimicrobial compositions can contain a sufficient amount of gelling agent such that the composition is a viscous liquid, gel, or semisolid that can be easily applied to, and rubbed on, the skin or other surface.

The term “gelling agent” as used here and hereafter refers to a compound capable of increasing the viscosity of a water-based composition, or capable of converting a water-based composition to a gel or semisolid. The gelling agent, therefore, can be organic in nature, for example, a natural gum or a synthetic polymer, or can be inorganic in nature.

The following are nonlimiting examples of gelling agents that can be used in the antimicrobial compositions contemplated herein. In particular, the following compounds, both organic and inorganic, act primarily by thickening or gelling the aqueous portion of the composition: acacia, agar, algin, alginic acid, ammonium alginate, ammonium chloride, ammonium sulfate, amylopectin, attapulgite, bentonite, C₉₋₁₅ alcohols, calcium acetate, calcium alginate, calcium carrageenan, calcium chloride, caprylic alcohol, carboxymethyl hydroxyethylcellulose, carboxymethyl hydroxypropyl guar, carrageenan, cellulose, cellulose gum, cetearyl alcohol, cetyl alcohol, corn starch, damar, dextrin, dibenzylidine sorbitol, ethylene dihydrogenated tallowamide, ethylene dioleamide, ethylene distearamide, gelatin, guar gum, guar hydroxypropyltrimonium chloride, hectorite, hyaluronic acid, hydrated silica, hydroxybutyl methylcellulose, hydroxyethylcellulose, hydroxyethyl ethylcellulose, hydroxyethyl stearamide-MIPA, hydroxypropylcellulose, hydroxypropyl guar, hydroxypropyl methylcellulose, isocetyl alcohol, isostearyl alcohol, karaya gum, kelp, lauryl alcohol, locust bean gum, magnesium aluminum silicate, magnesium silicate, magnesium trisilicate, methoxy PEG-22/dodecyl glycol copolymer, methylcellulose, microcrystalline cellulose, montmorillonite, myristyl alcohol, oat flour, ° leyl alcohol, palm kernel alcohol, pectin, PEG-2M, PEG-5M, polyvinyl alcohol, potassium alginate, potassium carrageenan, potassium chloride, potassium sulfate, potato starch, propylene glycol alginate, sodium carboxymethyl dextran, sodium carrageenan, sodium cellulose sulfate, sodium chloride, sodium silicoaluminate, sodium sulfate, stearalkonium bentonite, stearalkonium hectorite, stearyl alcohol, tallow alcohol, TEA-hydrochloride, tragacanth gum, tridecyl alcohol, tromethamine magnesium aluminum silicate, wheat flour, wheat starch, xanthan gum, and mixtures thereof.

The following additional nonlimiting examples of gelling agents act primarily by thickening the nonaqueous portion of the composition: abietyl alcohol, acrylinoleic acid, aluminum behenate, aluminum caprylate, aluminum dilinoleate, aluminum distearate, aluminum isostcarates/laurates/palmitates or stearates, aluminum isostearates/myristates, aluminum isostearates/palmitates, aluminum isostearates/stearates, aluminum lanolate, aluminum myristates/palmitates, aluminum stearate, aluminum stearates, aluminum tristearate, beeswax, behenamide, behenyl alcohol, butadiene/acrylonitrile copolymer, a C₂₉₋₇₀ acid, calcium behenate, calcium stearate, candelilla wax, carnauba, ceresin, cholesterol, cholesteryl hydroxystearate, coconut alcohol, copal, diglyceryl stearate malate, dihydroabietyl alcohol, dimethyl lauramine oleate, dodecanedioic acid/cetearyl alcohol/glycol copolymer, erucamide, ethylcellulose, glyceryl triacetyl hydroxystearate, glyceryl triacetyl ricinoleate, glycol dibehenate, glycol dioctanoate, glycol distearate, hexanediol distearate, hydrogenated C₆₋₁₄ olefin polymers, hydrogenated castor oil, hydrogenated cottonseed oil, hydrogenated lard, hydrogenated menhaden oil, hydrogenated palm kernel glycerides, hydrogenated palm kernel oil, hydrogenated palm oil, hydrogenated polyisobutene, hydrogenated soybean oil, hydrogenated tallow amide, hydrogenated tallow glyceride, hydrogenated vegetable glyceride, hydrogenated vegetable glycerides, hydrogenated vegetable oil, hydroxypropylcellulose, isobutylene/isoprene copolymer, isocetyl stearoyl stearate, Japan wax, jojoba wax, lanolin alcohol, lauramide, methyl dehydroabietate, methyl hydrogenated rosinate, methyl rosinate, methylstyrene/vinyltoluene copolymer, microcrystalline wax, montan acid wax, montan wax, myristyleicosanol, myristyloctadecanol, octadecene/maleic anhydride copolymer, octyldodecyl stearoyl stearate, oleamide, oleostearine, ouricury wax, oxidized polyethylene, ozokerite, palm kernel alcohol, paraffin, pentaerythrityl hydrogenated rosinate, pentaerythrityl rosinate, pentaerythrityl tetraabietate, pentaerythrityl tetrabehenate, pentaerythrityl tetraoctanoate, pentaerythrityl tetraoleate, pentaerythrityl tetrastearate, phthalic anhydride/glycerin/glycidyl decanoate copolymer, phthalic/trimellitic/glycols copolymer, polybutene, polybutylene terephthalate, polydipentene, polyethylene, polyisobutene, polyisoprene, polyvinyl butyral, polyvinyl laurate, propylene glycol dicaprylate, propylene glycol dicocoate, propylene glycol diisononanoate, propylene glycol dilaurate, propylene glycol dipelargonate, propylene glycol distearate, propylene glycol diundecanoate, PVP/eicosene copolymer, PVP/hexadecene copolymer, rice bran wax, stearalkonium bentonite, stearalkonium hectorite, stearamide, stearamide DEA-distearate, stearamide DIBA-stearate, stearamide MEA-stearate, stearone, stearyl alcohol, stearyl erucamide, stearyl stearate, stearyl stearoyl stearate, synthetic beeswax, synthetic wax, trihydroxystearin, triisononanoin, triisostearin, triisostearyl tri linoleate, tri laurin, trilinoleic acid, trilinolein, trimyristin, triolein, tripalmitin, tristearin, zinc laurate, zinc myristate, zinc neodecanoate, zinc rosinate, zinc stearate, and mixtures thereof.

Exemplary gelling agents useful in the antimicrobial compositions contemplated herein include, but are not limited to,

| | |
|---|---|
| Polyethylene Glycol & Propylene Glycol & Water | (ACULYN 44) |
| Ammonium Acrylatedimethyltaurate/VP Copolymer | (ARISTOFLEX AVC) |
| Glyceryl Stearate & PEG 100 Stearate | (ARLACEL 165) |
| Polyethylene(2)Stearyl Ether | (BRIJ 72) |
| Polyoxyethylene(21)Stearyl Ether | (BRIJ 721) |
| Silica | (CAB-O-SIL) |
| Polyquaternium 10 | (CELQUAT CS230M) |
| Cetyl Alcohol | |
| Cetearyl Alcohol & Cetereth 20 | (COSMOWAX P) |
| Cetearyl Alcohol & Dicetyl Phosphate & Ceteth-10 Phosphate | (CRODAFOS CES) |
| Ceteth-20 Phosphate & Cetearyl Alcohol & Dicetyl Phosphate | (CRODAFOS CS-20 Acid) |
| Cetearyl Alcohol & Cetereth 20 | (EMULGADE NI 1000) |
| Sodium Magnesium Silicate | (LAPONITE XLG) |
| Cetyl Alcohol & Stearyl Alcohol & Stearalkonium Chloride & | (MACKADET CBC) |
| Dimethyl Stearamine & Lactic Acid | |
| Cetearyl Alcohol & Stearamidopropyldimethylamine & | (MACKERNIUM |
| Stearamidopropylalkonium Chloride | Essential) |
| Stearalkonium Chloride | (MACKERNIUM SDC-85) |
| Cetearyl Alcohol & Stearamidopropyldimethylamine & | (MACKERNIUM Ultra) |
| Stearamidopropylalkonium Chloride & Silicone Quaternium 16 | |
| Cetearyl Alcohol & Cetearyl Glucoside | (MONTANOV 68EC) |
| Hydroxyethylcellulose | (NATROSOL 250 HHR |
| | CS) |
| Polyquaternium-37 & Mineral Oil & Trideceth-6 | (SALCARE SC 95) |
| Polyquaternium-32 & Mineral Oil & Trideceth-6 | (SALCARE SC 96) |
| Stearic Acid | |
| Cetyl Hydroxyethylcellulose | (NATROSOL Plus 330 CS) |
| Polyvinyl Alcohol, PVP-K30, Propylene Glycol | |
| Stearic Acid, Behenyl Alcohol, Glyceryl Stearate, Lecithin, | (PROLIPID 141) |
| C12-16 Alcohols, Palmic Acid | |
| Beeswax | (saponified beeswax) |
| Beeswax | (synthetic beeswax) |
| Water, Beeswax, Sesame Oil, Lecithin, Methyl paraben | (beesmilk) |
| Polyquaternium 10 | (CELQUAT SC240C) |
| Sodium Acrylate/Sodium Acrylodimethyl Taurate Copolymer | (SIMULGEL EG) |
| & Isohexadecane & Polysorbate 80 | |
| Polyquaternium 44 | (LUVIQUAT Care) |

Antimicrobial agents suitable for use in an antimicrobial composition contemplated herein include, but are not limited to, phenolic antimicrobial agents, quaternary ammonium antimicrobial agents, and analide and bisquanidine antimicrobial agents. Examples of phenolic antimicrobial agents include 2-hydroxydiphenyl compounds such as triclosan, phenol derivatives, and diphenyl compounds. Quaternary ammonium antimicrobial agents include, but are not limited to, behenalkonium chloride, cetalkonium chloride, cetarylalkonium bromide, cetrimonium tosylate, cetyl pyridinium chloride, lauralkonium bromide, lauralkonium chloride, lapyrium chloride, lauryl pyridinium chloride, myristalkonium chloride, olcalkonium chloride, and isostearyl ethyldimonium chloride. Preferred quaternary ammonium antimicrobial agents include benzalkonium chloride, benzethonium chloride, cetyl pyridinium bromide, and methylbenzethonium chloride. Useful analide and bisguanadine antimicrobial agents include, but are not limited to, triclocarban, carbanilide, salicylanilide, tribromosalan, tetrachlorosalicylanilide, fluorosalan, chlorhexidine gluconate, chlorhexidine hydrochloride, and mixtures thereof.

pH

The pH of the composition is sufficiently low such that at least a portion of the organic acid ester is in the protonated form. The organic acid ester then has the capability of lowering surface pH, such as skin pH, to provide an effective viral control, without irritating the skin. The organic acid ester also deposits on the skin, and resists removal by rinsing, to provide a persistent antiviral effect. In this regard, the pH of the antimicrobial compositions contemplated herein is less than about 5, preferably less than about 4.5, and more preferably less than about 4, at 25° C.

The following are exemplary embodiments of antimicrobial compositions contemplated herein, with each of the components set forth in weight percent of the antimicrobial composition. The examples are provided for illustration purposes only and are not meant to limit the various embodiments of the compositions in any way.

### Example 1

| Ingredient | Wt. % |
|---|---|
| Deionized water | 62.05 |
| Mackadet CBC | 5.20 |
| Ceraphyl 368 (octyl palmitate) | 1.75 |
| (an emollient) | |
| Neobee M20 | 2.00 |
| (propylene glycol | |
| di(octanoate/decanoate) | |
| (an emollient) | |
| Citric acid 1-ethyl ester | 2.00 |
| Malic acid 1-ethyl ester | 2.00 |
| Ethanol | 25.00 |
| Triethanolamine | q.s |
| Total | 100.00 |

### Example 2

| Ingredient | Wt. % |
|---|---|
| Deionized water | 87.05 |
| Mackadet CBC | 5.20 |
| Ceraphyl 368 (octyl palmitate) | 1.75 |
| (an emollient) | |
| Neobee M20 | 2.00 |
| (propylene glycol | |
| di(octanoate/decanoate) | |
| (an emollient) | |
| Citric acid 1-ethyl ester | 2.00 |
| Malic acid 1-ethyl ester | 2.00 |
| Ethanol | 0.00 |
| Triethanolamine | q.s |
| Total | 100.00 |

### Example 3

| Ingredient | Wt. % |
|---|---|
| Anhydrous citric acid | 1.5 |
| Citric acid 2-ethyl ester | 0.25 |
| Citric acid 1-ethyl ester | 0.25 |
| Malic acid | 1.3 |
| Malic acid 1-ethyl ester | 0.4 |
| Malic acid 2-ethyl ester | 0.25 |
| Malic acid diethyl ester | 0.05 |
| Ethyl alcohol (190 proof) | 62.0 |
| Purified water | 28.4 |
| Isopropyl palmitate | 1.0 |
| Cetyl alcohol | 1.0 |
| Dimethicone | 1.0 |
| Glycerin, 99% | 1.0 |
| Carbomer | 1.0 |
| Hydroxyethyl cellulose | 0.5 |
| Sodium hydroxide | 0.1 |
| Total | 100.00 |

### Example 4

| Ingredient | Wt. % |
|---|---|
| Anhydrous citric acid | 1.0 |
| Citric acid 2-ethyl ester | 0.5 |
| Citric acid 1-ethyl ester | 0.5 |
| Malic acid | 1.0 |
| Malic acid 1-ethyl ester | 0.6 |
| Malic acid 2-ethyl ester | 0.3 |
| Malic acid diethyl ester | 0.1 |
| Ethyl alcohol (190 proof) | 62.0 |
| Purified water | 28.4 |
| Isopropyl palmitate | 1.0 |
| Cetyl alcohol | 1.0 |
| Dimethicone | 1.0 |
| Glycerin, 99% | 1.0 |
| Carbomer | 1.0 |
| Hydroxyethyl cellulose | 0.5 |
| Sodium hydroxide | 0.1 |
| Total | 100.00 |

Accordingly, antimicrobial compositions comprising virucidally effective amounts of organic acid esters having pKₐ₁ values in the range of from 3 to about 4.5 and having pH values of no greater than about 5 at 25° C. are provided. The antimicrobial compositions are capable of lowering the pH of a surface so as to kill a virus and/or a bacterium immediately upon contact and also have a buffering capacity that suppresses pH, thus providing persistent acidification of viruses. The antimicrobial compositions may also comprise disinfecting alcohol in an amount of up to about 75 wt. %. The disinfecting alcohol acts synergistically with the organic acid esters to effectively control a broad spectrum of bacteria. In addition, the antimicrobial compositions may comprise organic acids. In particular, parent organic acids and esters from the parent organic acids can be used together to optimize properties of the antimicrobial compositions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An antimicrobial composition comprising:
a virucidally effective amount of a first organic acid ester, the first organic acid ester having a pKₐ₁ value in the range of from about 3 to about 4.5;
a disinfecting alcohol in an amount of 0 wt. % to about 75 wt. %; and
a carrier,
wherein the antimicrobial composition has a pH of no greater than about 5 at 25° C.

2. The antimicrobial composition of claim 1, wherein the first organic acid ester has the pKₐ, value in the range of from about 3.5 to about 4.

3. The antimicrobial composition of claim 1, wherein the first organic acid ester is a hydrophobic organic acid ester.

4. The antimicrobial composition of claim 1, wherein the first organic acid ester has a log P of no less than one.

5. The antimicrobial composition of claim 4, further comprising a second organic acid ester having a log P of less than one.

6. The antimicrobial composition of claim 5, further comprising the disinfecting alcohol in an amount of from about 25 wt. % to about 75 wt %.

7. The antimicrobial composition of claim 1, wherein the disinfecting alcohol is present in an amount greater than 0 wt. % and less than about 25 wt. %.

8. The antimicrobial composition of claim 1, wherein the first organic acid ester is present in an amount of from about 0.05 wt. % to about 6 wt. %.

9. The antimicrobial composition of claim 1, wherein the disinfecting alcohol is selected from the group consisting of methanol, ethanol, propanol, and isopropyl alcohol.

10. The antimicrobial composition of claim 1, further comprising an organic acid.

11. The antimicrobial composition of claim 10, wherein the first organic acid ester is an ester of the organic acid.

12. The antimicrobial composition of claim 1, further comprising a functional additive selected from the group consisting of hydrotropes, polyhydric solvents, gelling agents, antimicrobial agents, dyes, fragrances, pH adjusters, thickeners, viscosity modifiers, chelating agents, skin conditioners, emollients, preservatives, buffering agents, antioxidants, chelating agents, and opacifiers.

13. The antimicrobial composition of claim 1, wherein the first organic acid ester is selected from the group consisting of the 1-ethyl ester, 2-ethyl ester, 1,2-diethyl ester, and 1,3-diethyl ester of citric acid and malic acid 1-ethyl ester.

14. The antimicrobial composition of claim 1, wherein the carrier is water.

15. A method of reducing a bacterial population, a virus population, or a combination thereof on a surface comprising contacting the surface with a composition, the composition comprising:
a virucidally effective amount of a first organic acid ester, the first organic acid ester having a pKₐ₁ value in the range of from about 3 to about 4.5;
a disinfecting alcohol in an amount of 0 wt. % to about 75 wt. %; and
a carrier,
wherein the composition has a pH of no greater than about 5 at 25° C.

16. The method of claim 15, wherein the step of contacting comprises contacting the surface with the composition comprising the first organic acid ester having the pKₐ₁ value in the range of from about 3.5 to about 4.

17. The method of claim 15, wherein the step of contacting comprises contacting the surface with the composition comprising the first organic acid ester, wherein the first organic acid ester has a log P of no less than one.

18. The method of claim 17, wherein the step of contacting comprises contacting the surface with the composition further comprising a second organic acid ester having a log P of less than one.

19. The method of claim 18, wherein the step of contacting comprises contacting the surface with the composition further comprising the disinfecting alcohol in an amount of from about 25 wt. % to about 75 wt. %.

20. The method of claim 15, wherein the step of contacting comprises contacting the surface with the composition comprising the disinfecting alcohol present in an amount greater than 0 wt. % and less than about 25 wt. %.

21. The method of claim 15, wherein the step of contacting comprises contacting the surface with the composition comprising the first organic acid ester, wherein the first organic acid ester is present in an amount of from about 0.05 wt. % to about 6 wt. %.

22. The method of claim 15, wherein the step of contacting comprises contacting the surface with the composition comprising the disinfecting alcohol, wherein the disinfecting alcohol is selected from the group consisting of methanol, ethanol, propanol, and isopropyl alcohol.

23. The method of claim 15, wherein the step of contacting comprises contacting the surface with the composition further comprising an organic acid.

24. The method of claim 23, wherein the step of contacting comprises contacting the surface with the composition comprising the first organic acid ester that is an ester of the organic acid.

25. A method of reducing a bacterial population, a virus population, or a combination thereof on a surface comprising the steps of:
selecting an organic acid having a first value of a property;
selecting an ester of the organic acid, the ester having a pKₐ₁ value in the range of from about 3 to about 4.5 and having a second value of the property, wherein the first value is not equal to the second value;
combining the organic acid and the ester of the organic acid with a carrier to form an antimicrobial composition having a pH of no greater than about 5 at 25° C.; and
contacting the surface with the antimicrobial composition.

26. The method of claim 25, wherein the step of selecting the organic acid comprises selecting the organic acid having the first value of water solubility, a partition coefficient, a melting point, Hansen dispersion parameter, Hansen hydrogen bonding parameter, a sum of partial positive charges, or density.

27. The method of claim 25, wherein the step of combining further comprises combining the organic acid and the ester of the organic acid with a disinfecting alcohol in an amount no greater than 75 wt. %.

28. The method of claim 27, wherein the step of combining the organic acid and the ester of the organic acid with the disinfecting alcohol comprises combining the organic acid and the ester of the organic acid with the disinfecting alcohol in an amount of about 25 wt. % to about 75 wt. %.

29. The method of claim 25, wherein the step of selecting the ester comprises selecting the ester having the pKₐ₁ value in the range of from about 3.5 to about 4.

30. The method of claim 25, wherein the step of selecting the ester comprises selecting the ester having a log P of no less than one.
